(19) United States
(12) Patent Application Publication
(10) Pub. No.: US 2026/0084747 A1
(43) Pub. Date: Mar. 26, 2026

(54) Tracked Vehicle Steering System

(71) Applicant: David Boon, Salida, CO (US)

(72) Inventor: David Boon, Salida, CO (US)

(21) Appl. No.: 19/221,506

(22) Filed: May 29, 2025

Related U.S. Application Data
(60) Provisional application No. 63/653,208, filed on May 29, 2024.

(51) Int. Cl. B62D 11/18

(52) U.S. Cl. CPC B62D 11/18

(57) ABSTRACT

A tracked vehicle steering system is described. Embodiments of the tracked vehicle system can include, but is not limited to, a tracked vehicle and a hydraulic system. The hydraulic system can be implemented to steer the tracked vehicle by applying a negative torque via one or more hydraulic pumps to components of the tracked vehicle.

### CROSS-REFERENCE TO RELATED APPLICATION

This application claims the benefit of U.S. Provisional Application No. 63/653,208, filed May 29, 2024.

### BACKGROUND

Tracked vehicle steering systems are essential for maneuvering vehicles including tanks, and bulldozers. Tracked vehicle steering systems are also used for agricultural machinery and construction machinery that use continuous tracks instead of wheels. Currently available tracked vehicle steering systems are designed to control a relative speed or direction (forwards or backwards) of left and right tracks to achieve steering. Tracked vehicle steering systems can include, but are not limited to, differential steering, clutch-brake steering, controlled differential, hydraulic steering, and electric drive steering. Currently available tracked vehicle steering systems include several disadvantages including, but not limited to: high power loss due to friction causing track wear and surface damage; inefficiency due to power loss and wear on components; complexity and cost; robust maintenance; and currently available energy-dense battery technology is limiting.

A reliable, cost-effective, retro-fitting steering system is needed for tracked vehicles.

### BRIEF DESCRIPTION OF THE DRAWINGS

FIG. 1 is a block diagram of a tracked vehicle steering system according to one embodiment of the present invention.

FIGS. 2A-2B include block diagrams of a tracked vehicle steering system according to one embodiment of the present invention.

FIG. 3 is a perspective view of a valve body according to one embodiment of the present invention.

FIGS. 4A-4E include cross-sectional views of a valve body and valve spool location according to embodiments of the present invention.

### DETAILED DESCRIPTION

Embodiments of the present invention include a steering system for a tracked vehicle. The steering system can be implemented with hydraulic braking capabilities to aid in steering the tracked vehicle. Typically, a pair of hydraulic pumps (or motors) can each be operatively connected to different axles of a tracked vehicle. The hydraulic pumps can be implemented to slow down an axle, and thus steer the vehicle, based on actions of a driver. Typically, an open differential can be implemented where axles on either side of the open differential spin independently of one another. Of significant note, the hydraulic pumps can be implemented as brakes to slow down either track to turn the tracked vehicle.

In one embodiment, the tracked vehicle steering system can include, but is not limited to, a tracked vehicle and a hydraulic system. The tracked vehicle can have at least an internal combustion engine and a drivetrain. The hydraulic system can include, but is not limited to, a first hydraulic pump, a second hydraulic pump, a valve body, and a fluid reservoir. The first hydraulic pump and the second hydraulic pump can be operatively connected to components of the drivetrain. The drivetrain can typically include an open differential, a first axle, and a second axle. The first hydraulic pump can be operatively connected to the first axle and the second hydraulic pump can be operatively connected to the second axle. The hydraulic system can be implemented as a drivetrain brake to help steer the tracked vehicle. More specifically, an output flow of the first hydraulic pump or the second hydraulic pump can be reduced to apply a negative torque to an axle, thus effectively braking that axle. As the axle is slowed down or stopped completely, the other axle can continue to rotate allowing the tracked vehicle to turn about the braked axle side. The valve body can be implemented to alter an input/output of the hydraulic pumps. Of note, the hydraulic system can be retrofitted to an existing tracked vehicle and/or can be integrated into a new tracked vehicle build.

In a first example embodiment, a tracked vehicle steering system can include, but is not limited to, a tracked vehicle and a hydraulic system. The tracked vehicle can include at least an internal combustion engine, a drive shaft, a differential, a first axle, and a second axle. The differential is an open differential. The hydraulic system can include at least a valve body, a first hydraulic pump, a second hydraulic pump, and a fluid reservoir. The first hydraulic pump can be coupled to the first axle and fluidly connected to the valve body. The first hydraulic pump can be adapted to apply a negative torque to the first axle. The second hydraulic pump can be coupled to the second axle and fluidly connected to the valve body. The second hydraulic pump can be adapted to apply a negative torque to the second axle. The fluid reservoir can be fluidly connected to the valve body. The valve body can be defined by a first inlet port, a second inlet port, a first outlet port, a second outlet port, a plurality of reservoir ports, and a spool valve. The first inlet port and the first outlet port can be for the first hydraulic pump. The second inlet port and the second outlet port can be for the second hydraulic pump. The plurality of reservoir ports can be for the reservoir. The spool valve can be adapted to at least partially block one or more of the ports. The spool valve is operatively connected to a steering mechanism of the tracked vehicle.

To drive the tracked vehicle straight, the spool valve can be in a first position in the valve body. In the first position, the spool valve (i) can block each port of the plurality of reservoir ports, (ii) can not block the first inlet port and the first outlet port, and (iii) can not block the second inlet port and the second outlet port. To make a full right turn, the spool valve can be in a second position in the valve body. In the second position, the spool valve (i) can block one port of the plurality of reservoir ports, (ii) can not block the first inlet port and the first outlet port, and (iii) can block the second inlet port and the second outlet port. To make a partial right turn, the spool valve can be in a third position in the valve body. In the third position, the spool valve (i) can partially block three ports of the plurality of reservoir ports, (ii) can block one port of the plurality of reservoir ports (iii) can not block the first inlet port and the first outlet port, and (iv) can partially block the second inlet port and the second outlet port. To make a full left turn, the spool valve can be in a fourth position in the valve body. In the fourth position, the spool valve (i) can block one port of the plurality of reservoir ports, (ii) can block the first inlet port and the first outlet port, and (iii) can not block the second inlet port and the second outlet port. To make a partial left turn, the spool valve can be in a fifth position in the valve body. In the fifth position, the spool valve (i) can partially block three ports of the plurality of reservoir ports, (ii) can block one port of the plurality of reservoir ports (iii) can partially block the first inlet port and the first outlet port, and (iv) cab not block the second inlet port and the second outlet port.

In a second example embodiment, a tracked vehicle steering system can include, but is not limited to, a tracked vehicle and a hydraulic system. The tracked vehicle can include at least an internal combustion engine, a drive shaft, a differential, a first axle, a second axle, a first drive wheel, and a second drive wheel. The hydraulic system can include at least a valve body, a first hydraulic pump, a second hydraulic pump, and a fluid reservoir. the hydraulic system is an open loop system. The first hydraulic pump can be coupled to the first drive wheel and can be fluidly connected to the valve body.

The second hydraulic pump can be coupled to the second drive wheel and can be fluidly connected to the valve body. The fluid reservoir can be fluidly connected to the valve body. The valve body can be defined by a first inlet port, a second inlet port, a first outlet port, a second outlet port, a plurality of reservoir ports, and a spool valve. The first inlet port and the first outlet port can be for the first hydraulic pump. The second inlet port and the second outlet port can be for the second hydraulic pump. The plurality of reservoir ports can be for the reservoir. The spool valve can be adapted to at least partially block one or more of the ports. The first inlet port, the second inlet port, and a first pair of ports of the plurality of reservoir ports can be arranged in a row in a first location on the valve body. The first outlet port, the second outlet port, and a second pair of ports of the plurality of reservoir ports can be arranged in a row in a second location opposite the first location on the valve body.

The first hydraulic pump is adapted to apply a negative torque to the first drive wheel. To begin a partial right turn, the spool valve can be moved to a first position in the valve body. In the first position, the spool valve can initiate a right turn by (i) partially blocking (a) three ports of the plurality of reservoir ports, (b) the second inlet port, and (c) the second outlet port, and (ii) blocking one port of the plurality of reservoir ports. To perform a full right turn, the spool valve can be moved to a second position in the valve body. In the second position, the spool valve can cause a right turn by blocking (i) one port of the plurality of reservoir ports, (ii) the second inlet port, and (ii) the second outlet port.

The second hydraulic pump is adapted to apply a negative torque to the second drive wheel. To initiate a partial left turn, the spool valve can be moved to a third position in the valve body. In the third position, the spool valve can initiate a left turn by (i) partially blocking (a) three ports of the plurality of reservoir ports, (b) the first inlet port, and (c) the first outlet port, and (ii) blocking one port of the plurality of reservoir ports. To perform a full left turn, the spool valve can be moved to a fourth position in the valve body. In the fourth position, the spool valve can cause a left turn by the spool valve (i) blocking one port of the plurality of reservoir ports, (ii) the first inlet port, and (iii) the first outlet port.

In a third example embodiment, a tracked vehicle steering system can include, but is not limited to, a tracked vehicle and a hydraulic system. The tracked vehicle can include at least an internal combustion engine, a drive shaft, an open differential, a first axle, a second axle, and a steering mechanism. The hydraulic system can include a valve body, a first hydraulic pump, a second hydraulic pump, and a fluid reservoir. The valve body can be operatively connected to the steering mechanism. The first hydraulic pump can be (i) coupled to the first axle, (ii) adapted to apply a negative torque to the first axle, and (iii) fluidly connected to the valve body. The second hydraulic pump can be (i) coupled to the second axle, (ii) adapted to apply a negative torque to the second axle, and (iii) fluidly connected to the valve body. The fluid reservoir can be fluidly connected to the valve body. The valve body can consist essentially of (i) a first port and a second port operatively connected to the first hydraulic pump, (ii) a third port and a fourth port operatively connected to the second hydraulic pump, and (iii) a fifth port, a sixth port, a seventh port, and an eighth operatively connected to the fluid reservoir. The spool valve can be adapted to at least partially block one or more of the ports. The first port, the fourth port, the fifth port, and the sixth port can be arranged in a row in a first location on the valve body. The second port, the third port, the sixth port, and the seventh port can be arranged in a row in a second location opposite the first location on the valve body.

As previously mentioned, the steering mechanism of the tracked vehicle can be operatively connected to the spool valve. One or more means including, but not limited to, mechanically actuated, electrically actuated, and/or software-controlled can be implemented in embodiments of the present invention. In one instance, the steering mechanism can be implemented to control a lateral positioning of the spool valve within the valve body. A location of the spool valve in the valve body can determine which hydraulic ports are open, closed, or partially blocked, thereby steering the tracked vehicle.

In one embodiment, the steering mechanism can be selected from the group including, but not limited to, a manually operated lever, a wheel, and a joystick mechanically linked to the spool valve. As can be appreciated, a rotational shaft, a cable linkage, and/or a rack-and-pinion gear set may be implemented to operatively couple the steering mechanism to the spool valve. As a user moves the steering mechanism, the spool valve ca be displaced linearly (or rotationally) within the valve body. A degree of movement can be proportional to a desired steering radius, allowing precise modulation of fluid flow to the hydraulic pumps.

In another embodiment, the steering mechanism can include an electric actuator operatively and mechanically connected to the spool valve. The electric actuator can include, but is not limited to, a stepper motor, a servo motor, or a solenoid. In one instance, the actuator can be controlled by a control module (e.g., an electronic control unit (ECU) or microcontroller) which can interpret inputs from a steering interface (e.g., joystick, steering wheel, or control stick). A rotary encoder or linear position sensor may provide feedback to ensure accurate positioning of the spool valve.

In yet another embodiment, steering (via the spool valve) can be controlled through software by using one or more sensor inputs and control algorithms. The inputs may include speed sensors on each axle (or track), inertial measurement units (IMUs), GPS data, steering angle sensors, and hydraulic pressure sensors. A control module (or controller) can process sensor data and calculate a required spool valve position to achieve a desired turn. Commands may then be sent to an actuator to reposition the spool valve accordingly. Of note, control logic may include PID feedback or adaptive algorithms based on terrain, load, and operator inputs. In some instances, a dual-mode control can be employed, allowing for manual override of electronically or software-controlled systems in the event of a power failure or system malfunction.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium.

### Terminology

The terms and phrases as indicated in quotation marks (“”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

### An Embodiment of a Tracked Vehicle Steering System

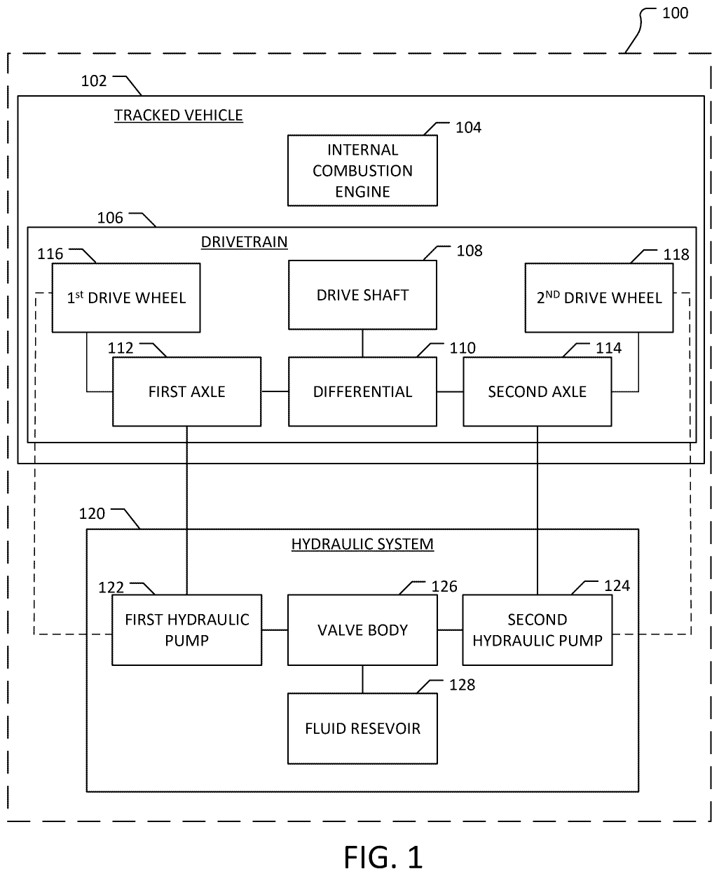

Referring to FIG. 1, a block diagram of an embodiment 100 of a tracked vehicle steering system is illustrated. As shown, the tracked vehicle steering system 100 can include, but is not limited to, a tracked vehicle 102 and a hydraulic system 120. The hydraulic system 120 can be operatively connected to one or more components of the tracked vehicle 102. Of note, the tracked vehicle steering system 100 can be retrofitted to an existing tracked vehicle or can be incorporated into a new vehicle.

The tracked vehicle 102 can typically include, but is not limited to, an internal combustion engine 104 and a drivetrain 106. The drivetrain 106 can include, but is not limited to, a drive shaft 108, a differential 110, a first axle 112, a second axle 114, a first drive wheel 116, and a second drive wheel 118. Typically, the differential 110 can be an open differential or limited-slip differential. The drive shaft 108 can be connected to the internal combustion engine 104 and the differential 110. The first axle 112 and the second axle 114 can be operatively connected to the differential 110. The first axle 112 can be operatively connected to the first drive wheel 116 and the second axle 114 can be operatively connected to the second drive wheel 118 of the tracked vehicle 102.

The hydraulic system 120 can include, but is not limited to, a first hydraulic pump 122, a second hydraulic pump 124, a valve body 126, and a fluid reservoir 128. The first hydraulic pump 122, the second hydraulic pump 124, and the fluid reservoir 128 can be fluidly connected to the valve body 126. Of note, the valve body 126 can be implemented to alter a flow of fluid through the components of the hydraulic system 120. For instance, by restricting a flow of fluid to the first hydraulic pump 122, the first hydraulic pump 122 can be slowed down.

As shown, the first hydraulic pump 122 can be fluidly connected to the valve body 126, the second hydraulic pump 124, and the fluid reservoir 128. The first hydraulic pump 122 can be operatively connected to the first axle 112. In another embodiment, as shown, the first hydraulic pump 122 can be operatively connected to the first drive wheel 116. More specifically, the internal combustion engine 104 can provide mechanical energy to the first hydraulic pump 122 via the drivetrain 106. For example, the first axle 112 can be rotated via the differential 110, which can be spun (or rotated) via the drive shaft 108. The rotation of the first axle 112 can power the first hydraulic pump 122.

The second hydraulic pump 124 can be fluidly connected to the valve body 126, the first hydraulic pump 122, and the fluid reservoir 128. The second hydraulic pump 124 can be operatively connected to the second axle 114 similar to the first hydraulic pump 122 and the first axle 112. In another embodiment, the second hydraulic pump 124 can be operatively connected to the second drive wheel 118.

The valve body 126 can be implemented to control fluid flow in the hydraulic system 120. Of note, the valve body 126 can be implemented to control steering by restricting output flow from the hydraulic pumps 122, 124. As can be appreciated, restricted fluid flow can create a pressure increase at a hydraulic pump output causing braking torque on an axle.

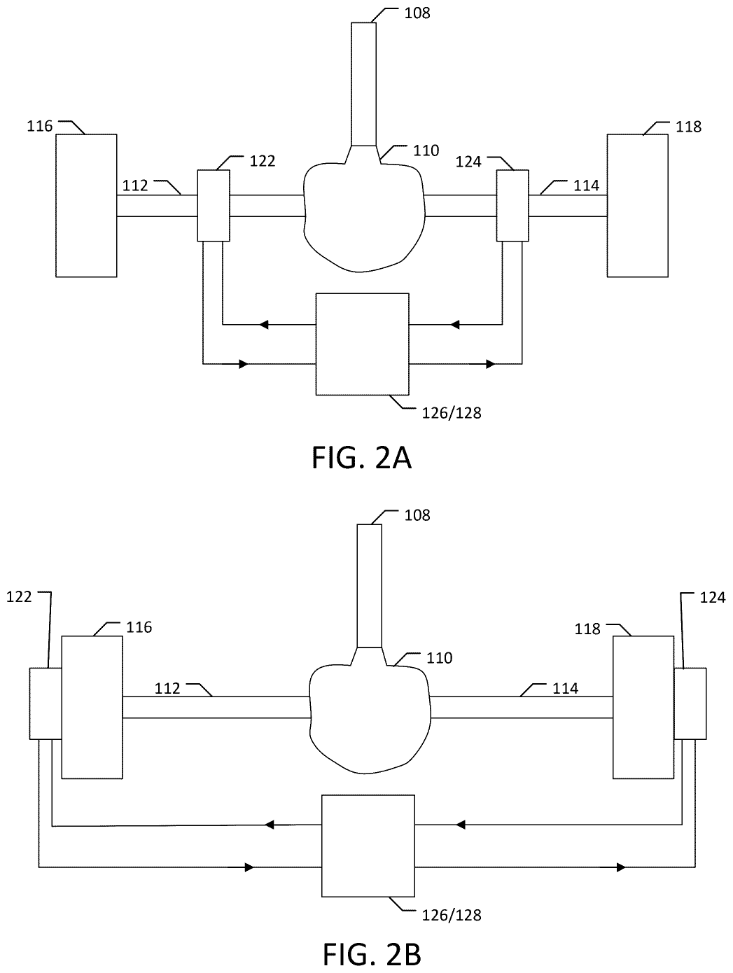

Referring to FIG. 2A, a detailed diagram of one example embodiment of the tracked vehicle steering system 100 is illustrated. Of note, the hydraulic pumps 122, 124 can be directly connected to the axles 112, 114 of the drivetrain 106. As can be appreciated, the axles 112, 114 can be operatively connected to the hydraulic pumps 122, 124 by being implemented as a drive shaft for the hydraulic pumps. As the axles 112, 114 are rotated by the motion of the drive shaft 108 via the differential 110, the fluid can be moved in the hydraulic system 120. A first fluid output of the fluid reservoir 128 can be connected to a fluid input of the first hydraulic pump 122. A fluid output of the first hydraulic pump 122 can be connected to a first fluid input of the reservoir. A second fluid output of the fluid reservoir 128 can be connected to a fluid input of the second hydraulic pump 124. A fluid output of the second hydraulic pump 124 can be connected to a second fluid input of the fluid reservoir 128. A fluid flow of the hydraulic system 120 can be shown via arrows in FIG. 2A. Of note, in such an instance, the tracked vehicle 102 can be moving in a forward motion.

The tracked vehicle steering system 100 can be implemented to aid the tracked vehicle 102 to turn left and right. To start a left turn, the valve body 126 can restrict an output flow from the first hydraulic pump 122. When the output flow may be restricted from the first hydraulic pump 122, a resistance torque can be applied to the first axle 112 via the first hydraulic pump 122. Of note, the resistance torque applied by the first hydraulic pump 122 can slow down the first axle 112 by allowing the second axle 124 to be rotating faster. As such, the tracked vehicle 102 can begin to turn left. To start a right turn, the valve body 126 can restrict an output flow from the second hydraulic pump 124. When the output flow may be restricted from the second hydraulic pump 124, a resistance torque can be applied to the second axle 114 via the second hydraulic pump 124. The resistance torque can slow down the second axle 114, allowing the first axle 112 to be rotating faster and thus allowing the tracked vehicle 102 to turn right.

Referring to FIG. 2B, a detailed diagram of a second example embodiment of the tracked vehicle steering system 100 is illustrated. Of note, the hydraulic pumps 122, 124 can be connected to the drive wheels 116, 118 of the tracked vehicle 102. The drive wheels 116, 118 can be implemented as a drive shaft for the hydraulic pumps 122, 124. To start a left turn, the valve body 126 can restrict an output flow from the first hydraulic pump 122. When the output flow may be restricted from the first hydraulic pump 122, a resistance torque can be applied to the first drive wheel 116 via the first hydraulic pump 122. As previously mentioned, the resistance torque can slow down the first axle 112 allowing the second axle 114 to be rotating faster. The tracked vehicle 102 may then start to turn left with control of the turn based on the amount of resistance torque applied via the first hydraulic pump 122. To start a right turn, the valve body 124 can restrict an output flow from the second hydraulic pump 124. When the output flow may be restricted from the second hydraulic pump 124, a resistance torque can be applied to the second drive wheel 118 via the second hydraulic pump 124. The resistance torque can slow down the second axle 114 allowing the first axle 112 to be rotating faster and thus allowing the tracked vehicle 102 to turn right.

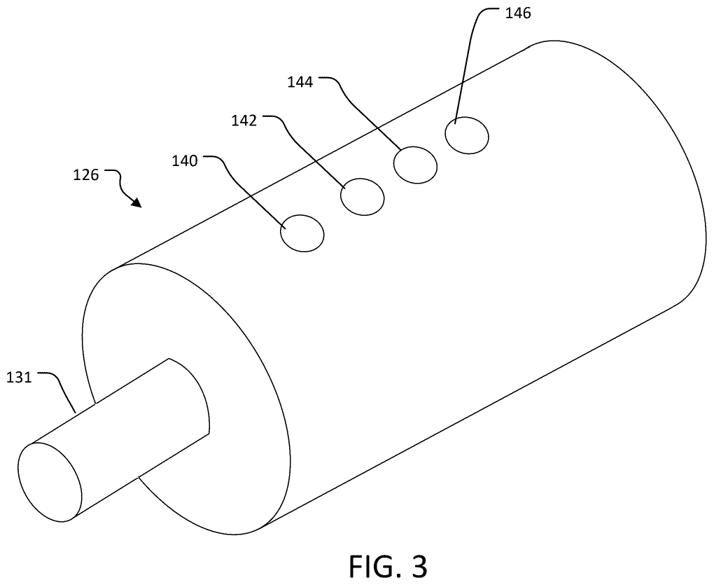

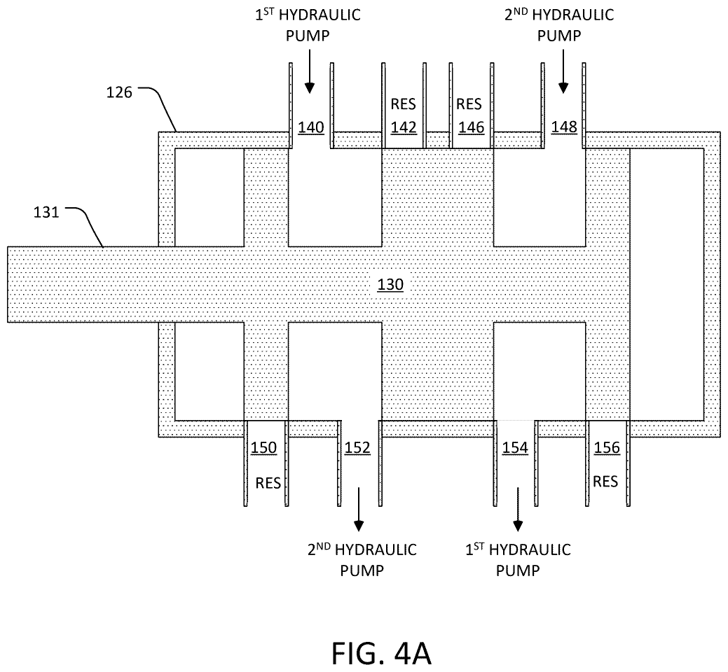

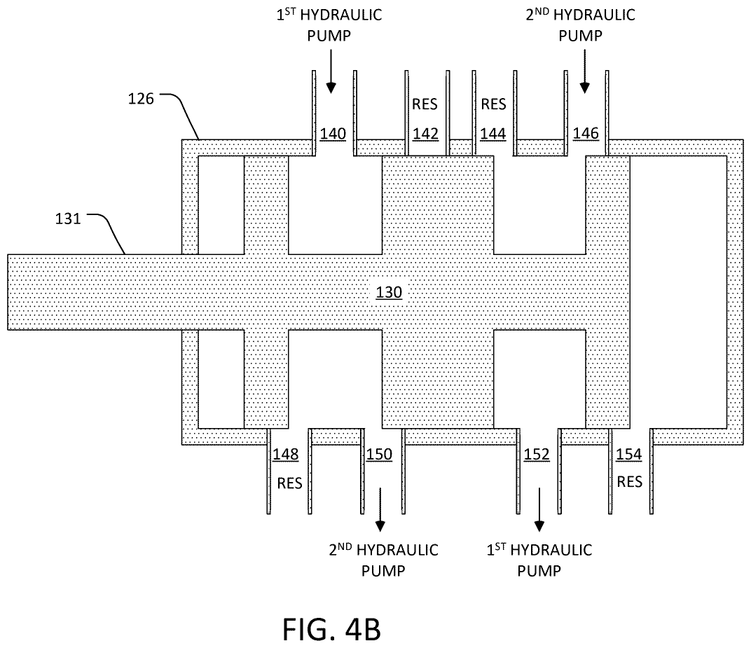

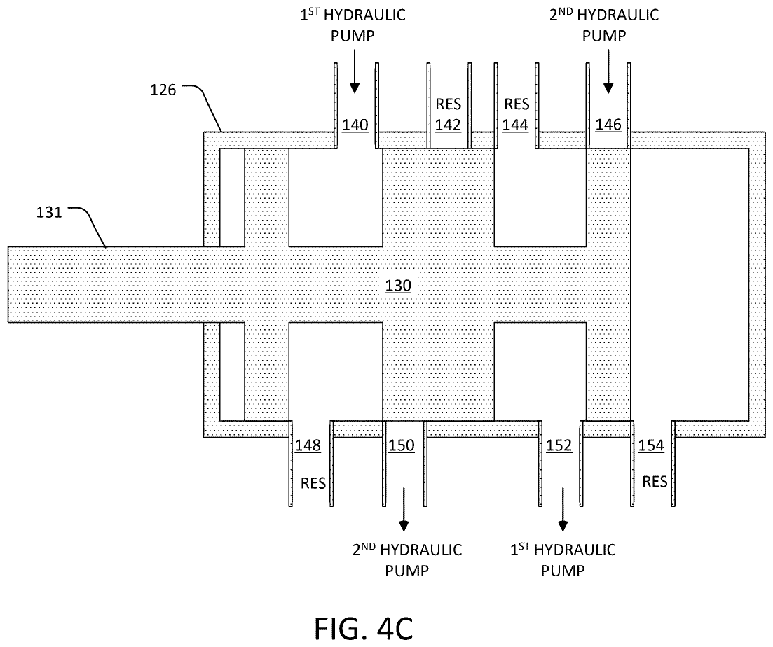

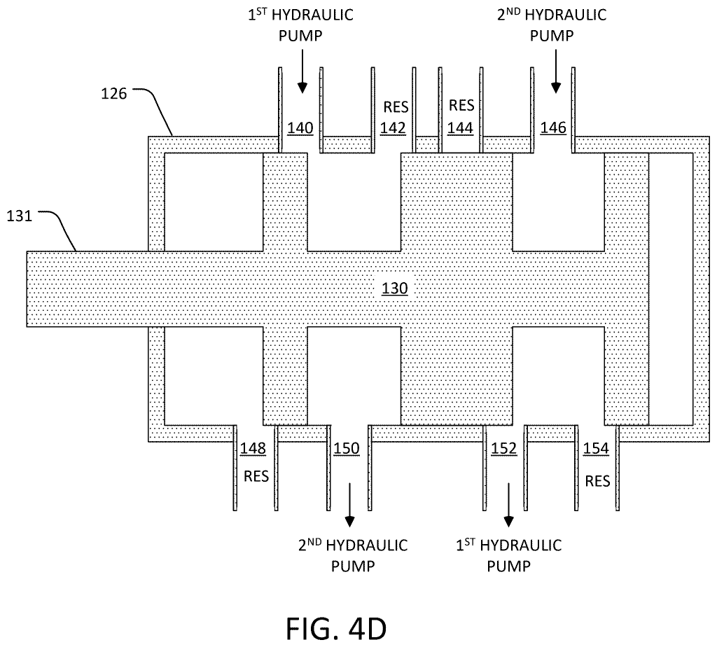

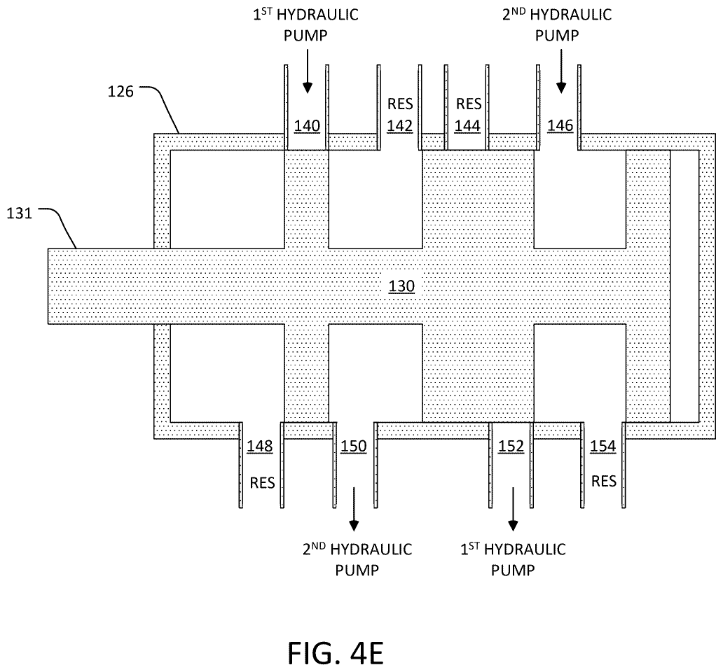

Referring to FIG. 3, a perspective view of one example embodiment of the valve body 126 is illustrated. Of note, the valve body 126 can include a valve spool 130 (shown in FIGS. 4A-4E) having a shaft 131 protruding from the valve body 126 that can be operatively connected to a steering mechanism (or device) of the tracked vehicle 102. The shaft 131 can be part of the valve spool 130 located exteriorly of the valve body 126. The steering device can be implemented to engage the shaft 131 to alter which valves of the valve body 126 are open and closed. Of note, the valve body 126 can control flow between the first hydraulic pump 122, the second hydraulic pump 124, and the fluid reservoir 126. By controlling the flow, the valve body 126 can be implemented to “steer”the tracked vehicle.

The valve body 126 can include a plurality of ports 140-154 (shown generally in FIGS. 3-4E) that can be implemented to fluidly connect the hydraulic system 120 components. Of note, the ports 140-154 can be implemented as either an input to the valve body 126 or an output from the valve body 126. As previously mentioned, the valve body 126 can implement the valve spool 130 to open, close, and/or partially close the ports 140-154. Further, by providing a valve spool 130 that can move laterally in either direction in the valve body 126, the valve spool 130 can varyingly block one or more ports to provide smooth turning. More specifically, a user can determine how much torque resistance may be applied to either axle (or drive wheel) to dictate how hard of a turn is made. As previously mentioned, the valve spool 130 can include the shaft 131 located exteriorly to the valve body 126 that can be connected to a steering device of the tracked vehicle 102. The valve spool 130 can be moved laterally within the valve body 126 to open/close ports and control steering of the tracked vehicle 102.

Described hereinafter in FIGS. 4A-4E, detailed diagrams showing a general location of the valve spool 130 within the valve body 126 at different locations are illustrated. Of note, steering of the tracked vehicle 102 can be dictated based on a flow of fluid in the hydraulic system 120. The valve body 126 and a location of the valve spool 130 in the valve body 126 are not meant to be limiting but examples of implementing hydraulic pumps to aid in steering a tracked vehicle.

Referring to FIG. 4A, a cross-sectional view of the one example embodiment of the valve body 126 is illustrated. As shown, the valve body 126 can include a plurality of ports 140-154. The valve spool 130 can be configured to block (or partially block) at least 4 ports at once. Depending on a location of the valve spool 130, various ports can be open, closed, and/or partially open/closed. As shown, there can be an inlet port 140 and an outlet port 152 for the first hydraulic pump 122, an inlet port 146 and an outlet port 150 for the second hydraulic pump 124, a first inlet port 142 and a second inlet port 144 for the fluid reservoir 128, and a first outlet port 148 and a second outlet port 154 for the fluid reservoir 128.

When the tracked vehicle may be going straight, the inlets 140, 148 and the outlets 152, 154 for the first hydraulic pump 122 and the second hydraulic pump 124 can all be open allowing for a closed loop between the hydraulic pumps. As can be appreciated, the hydraulic pumps 122, 124 may not provide any resistive torque to the axles 112, 114. As can be appreciated, this may allow for the drive wheels 116, 118 and the axles 112, 114 to operate at the same rotational speed.

Referring to FIG. 4B, a cross-sectional view of the valve body 126 and a location of the valve spool 130 to initiate a right turn is illustrated. To initiate a right turn, the valve spool 130 can be moved forward (to the left) to partially block the inlet port 148 and the outlet port 152 of the second hydraulic pump 124. Of note, this can initiate a negative torque by limiting a rotation of the second hydraulic pump 124, which can slow the second axle 114. By slowing the second axle 114, the first axle 112 can be rotating faster resulting in the tracked vehicle 102 beginning to turn right.

Referring to FIG. 4C, a cross-sectional view of the valve body 126 and a location of the valve spool 130 to initiate a full right turn is illustrated. During a full right turn, the second axle 114 can be stopped from rotating to allow the tracked vehicle 102 to make a hard right turn. To initiate a full right turn, the valve spool 130 can be moved to the front of the valve body 126 (farther left in the valve body) to fully block the inlet port 146 and the outlet port 150 of the second hydraulic pump 124. As can be appreciated, this can stop the second hydraulic pump 124 from operating completely resulting in the second axle 114 stopping and not rotating. As shown, the valve spool 130 can completely block the inlet port 146 and the outlet port 150 of the second hydraulic pump 124 to form a closed loop between the first hydraulic pump 122 and the fluid reservoir 128.

Referring to FIG. 4D, a cross-sectional view of the valve body 126 and a location of the valve spool 130 to initiate a left turn is illustrated. To initiate a left turn, the valve spool 130 can be moved backward (to the right in the figure) to partially block the inlet port 140 and the outlet port 152 of the first hydraulic pump 122. Of note, this can initiate a negative torque by limiting a rotation of the first hydraulic pump 122, which can slow the first axle 112. By slowing the first axle 112, the second axle 114 can be rotating faster resulting in the tracked vehicle 120 beginning to turn left.

Referring to FIG. 4E, a cross-sectional view of the valve body 126 and a location of the valve spool 130 to initiate a full left turn is illustrated. During a full left turn, the first axle 112 can be stopped from rotating to allow the tracked vehicle 102 to make a hard left turn. To initiate a full left turn, the valve spool 130 can be moved to the back in the valve body 126 (farther right in the valve body) to fully block the inlet port 140 and the outlet port 152 of the first hydraulic pump 122. As can be appreciated, this can stop the first hydraulic pump 122 from operating completely resulting in the first axle 112 stopping and not rotating. As shown, the valve spool 130 can completely block the inlet port 140 and the outlet port 152 of the first hydraulic pump 122 to form a closed loop between the second hydraulic pump 124 and the fluid reservoir 128.

Of significant note, embodiments of the tracked vehicle steering system can allow for the ability to prevent self-steer. More specifically, the valve body can operate in a closed loop system to maintain equal speeds to both tracks. Stated alternatively, the axles are free to rotate without any resistance from the hydraulic pumps. As can be appreciated, embodiments are contemplated where the valve body is implemented with electronic controlled valves set to speed sensors.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A tracked vehicle steering system comprising:
a tracked vehicle having (i) an internal combustion engine, (ii) a driveshaft, (iii) a differential, (iv) a first axle, and (v) a second axle;
a hydraulic system having (i) a valve body, (ii) a first hydraulic pump coupled to the first axle and fluidly connected to the valve body, (iii) a second hydraulic pump coupled to the second axle and fluidly connected to the valve body, and (iv) a fluid reservoir fluidly connected to the valve body; and
the valve body being defined by:
a first inlet port and a first outlet port for the first hydraulic pump;
a second inlet port and a second outlet port for the second hydraulic pump;
a plurality of reservoir ports for the reservoir; and
a spool valve adapted to at least partially block one or more of the ports.

2. The tracked vehicle steering system of claim 1, wherein in a first position, the spool valve (i) blocks each port of the plurality of reservoir ports, (ii) does not block the first inlet port and the first outlet port, and (iii) does not block the second inlet port and the second outlet port.

3. The tracked vehicle steering system of claim 2, wherein in a second position, the spool valve (i) blocks one port of the plurality of reservoir ports, (ii) does not block the first inlet port and the first outlet port, and (iii) blocks the second inlet port and the second outlet port.

4. The tracked vehicle steering system of claim 3, wherein in a third position, the spool valve (i) partially blocks three ports of the plurality of reservoir ports, (ii) blocks one port of the plurality of reservoir ports, (iii) does not block the first inlet port and the first outlet port, and (iv) partially blocks the second inlet port and the second outlet port.

5. The tracked vehicle steering system of claim 2, wherein in a second position, the spool valve (i) blocks one port of the plurality of reservoir ports, (ii) blocks the first inlet port and the first outlet port, and (iii) does not block the second inlet port and the second outlet port.

6. The tracked vehicle steering system of claim 5, wherein in a third position, the spool valve (i) partially blocks three ports of the plurality of reservoir ports, (ii) blocks one port of the plurality of reservoir ports (iii) partially blocks the first inlet port and the first outlet port, and (iv) does not block the second inlet port and the second outlet port.

7. The tracked vehicle steering system of claim 1, wherein the spool valve is operatively connected to a steering mechanism of the tracked vehicle.

8. The tracked vehicle steering system of claim 1, the first hydraulic pump is adapted to apply a negative torque to the first axle.

9. The tracked vehicle steering system of claim 8, the second hydraulic pump is adapted to apply a negative torque to the second axle.

10. The tracked vehicle steering system of claim 1, wherein the differential is an open differential.

11. A tracked vehicle steering system comprising:
a tracked vehicle having (i) an internal combustion engine, (ii) a driveshaft, (iii) a differential, (iv) a first axle, (v) a second axle, (vi) a first drive wheel, and (vii) a second drive wheel;
a hydraulic system having (i) a valve body, (ii) a first hydraulic pump coupled to the first drive wheel and fluidly connected to the valve body, (iii) a second hydraulic pump coupled to the second drive wheel and fluidly connected to the valve body, and (iv) a fluid reservoir fluidly connected to the valve body; and
the valve body being defined by:
a first inlet port and a first outlet port for the first hydraulic pump;
a second inlet port and a second outlet port for the second hydraulic pump;
a plurality of reservoir ports for the reservoir; and
a spool valve adapted to at least partially block one or more of the ports.

12. The tracked vehicle steering system of claim 11, wherein the first hydraulic pump is adapted to apply a negative torque to the first drive wheel.

13. The tracked vehicle steering system of claim 12, wherein in a first position, the spool valve initiates a right turn by (i) partially blocking (a) three ports of the plurality of reservoir ports, (b) the second inlet port, and (c) the second outlet port, and (ii) blocking one port of the plurality of reservoir ports.

14. The tracked vehicle steering system of claim 13, wherein in a second position, the spool valve causes a right turn by blocking (i) one port of the plurality of reservoir ports, (ii) the second inlet port, and (iii) the second outlet port.

15. The tracked vehicle steering system of claim 11, wherein the second hydraulic pump is adapted to apply a negative torque to the second drive wheel.

16. The tracked vehicle steering system of claim 15, wherein in a first position, the spool valve initiates a left turn by (i) partially blocking (a) three ports of the plurality of reservoir ports, (b) the first inlet port, and (c) the first outlet port, and (ii) blocking one port of the plurality of reservoir ports.

17. The tracked vehicle steering system of claim 16, wherein in a second position, the spool valve causes a left turn by (i) blocking one port of the plurality of reservoir ports, (ii) the first inlet port, and (iii) the first outlet port.

18. The tracked vehicle steering system of claim 11, wherein the hydraulic system is an open loop system.

19. The tracked vehicle steering system of claim 11, wherein: (i) the first inlet port, the second inlet port, and a first pair of ports of the plurality of reservoir ports are arranged in a row in a first location on the valve body; and (ii) the first outlet port, the second outlet port, and a second pair of ports of the plurality of reservoir ports are arranged in a row in a second location opposite the first location on the valve body.

20. A tracked vehicle steering system comprising:
a tracked vehicle having (i) an internal combustion engine, (ii) a driveshaft, (iii) an open differential, (iv) a first axle, (v) a second axle, and (vi) a steering mechanism;
a hydraulic system having (i) a valve body operatively connected to the steering mechanism, (ii) a first hydraulic pump (a) coupled to the first axle, (b) adapted to apply a negative torque to the first axle, and (c) fluidly connected to the valve body, (iii) a second hydraulic pump (a) coupled to the second axle, (b) adapted to apply a negative torque to the second axle, and (c) fluidly connected to the valve body, and (iv) a fluid reservoir fluidly connected to the valve body; and
the valve body consisting essentially of:
a first port and a second port operatively connected to the first hydraulic pump;
a third port and a fourth port operatively connected to the second hydraulic pump;
a fifth port, a sixth port, a seventh port, and an eighth port operatively connected to the fluid reservoir; and
a spool valve adapted to at least partially block one or more of the ports;
wherein: (i) the first port, the fourth port, the fifth port, and the sixth port are arranged in a row in a first location on the valve body; and (ii) the second port, the third port, the sixth port, and the seventh port are arranged in a row in a second location opposite the first location on the valve body.
